(19) United States
(12) Patent Application Publication
(10) Pub. No.: US 2017/0017723 A1
(43) Pub. Date: Jan. 19, 2017

(54) SYSTEMS AND METHODS FOR DYNAMIC SOCIAL LINKING OF USE RECOLLECTION OF DREAMT CONTENT

(71) Applicant: Get to Know Your Brain Pte Ltd, Singapore (SG)

(72) Inventor: Aran Louise Dadswell, Singapore (SG)

(73) Assignee: Get to Know Your Brain Pte Ltd, Singapore (SG)

(21) Appl. No.: 15/124,278

(22) PCT Filed: Feb. 26, 2015
(86) PCT No.: PCT/SG2015/000056

§ 371 Date: Sep. 7, 2016

Related U.S. Application Data
(60) Provisional application No. 61/951,129, filed on Mar. 11, 2014.

(30) Foreign Application Priority Data
Mar. 11, 2014 (SG) 10201400562S

(51) Int. Cl. G06F 17/30; H04L 29/08

(52) U.S. Cl. CPC G06F 17/30867; H04L 67/10; G06Q 50/01

(57) ABSTRACT

A dynamic social linking system is disclosed for linking a dreamer user with other users that are associated with dreamer user's recollection or analysis of the dreamer user's dreamt content.

### FIELD

This invention relates generally to methods, and systems for social networking, and more particularly to systems and methods for dynamic social linking of dreamt content of conscious analysis or recollection of a user's dreamt or subconscious content.

### BACKGROUND

The study of dreams commonly involves the analysis of dream meaning. There are a number of facilities readily available that allow users to discuss and learn what the significance of each element of the dream as recalled by the dreamer. While discerning the “what” and “why” of the meaning of each element of the dream is important in the study of dreams, other aspects of the dreams of such as the “who” and “when” have not be subjected to the same attention.

There is a need for systems and methods that facilitate social linking between people in a network environment that connect users based on the recollection of the dream content of one user with another user appearing as the “who” and “when” of the dream content.

### SUMMARY OF THE INVENTION

According to a 1^{st} aspect of the present invention, we provide a dynamic social linking system for linking users within a network accessible to a plurality of users, the system comprising a processor configured to receive a dreamt content record of a recollection of a dream of the dreamer user, the dreamt content record comprising at least one target content associated with another user within the network; and a database for storing user details and associated target content registered within the network; the processor analysing dreamt content record of the dreamer user and identifying the target content within the dreamt content record associated with another user within the network, and notifying the user associated with the target content of the dreamt content record of the dreamer user.

According to a 2^{nd} aspect of the present invention, we provide a dynamic social linking method for linking users within a network accessible to a plurality of users, the system comprising receiving a dreamt content record of a recollection of a dream of the dreamer user, the dreamt content record comprising at least one target content associated with another user within the network; and storing user details and associated target content registered within the network; analysing dreamt content record of the dreamer user and identifying the target content within the dreamt content record associated with another user within the network, and notifying the user associated with the target content of the dreamt content record of the dreamer user.

### BRIEF DESCRIPTION OF THE FIGURES

The accompanying drawings incorporated herein and forming a part of the specification illustrate several aspects of the present invention and, together with the description, serve to explain the principles of the invention. While the invention will be described in connection with certain embodiments, there is no intent to limit the invention to those embodiments described. On the contrary, the intent is to cover all alternatives, modifications and equivalents as included within the scope of the invention as defined by the appended claims.

In the drawings:

FIG. 1 illustrates a block diagram of an exemplary system on which various embodiments of the invention may be implemented;

FIG. 2 illustrates a block diagram of an exemplary personal computer, user device or the like that may implemented in the system of FIG. 1 in accordance with an embodiment of the invention;

FIG. 3 illustrates a block diagram of an exemplary dream register network server that may be implemented in the system of FIG. 1 in accordance with an embodiment of the invention;

FIG. 4 illustrates a block diagram of an exemplary target content identification module that may be implemented in the server of FIG. 3 in accordance with an embodiment of the invention;

FIG. 5 illustrates a block diagram of an exemplary database that may be implemented in the system of FIG. 1 in accordance with an embodiment of the invention;

FIG. 6 illustrates a flow chart of a method in accordance with an embodiment of the invention;

FIGS. 7 and 8 illustrate schematics of a user device display with a graphical user interface showing input of content description in accordance with an embodiment of the invention; and

FIGS. 9 to 15 illustrate graphical user interfaces arranged to be displayed on a user device display showing input of content description in accordance with embodiments of the invention.

### DETAILED DESCRIPTION

A dynamic social linking system is disclosed for linking a dreamer user with other users that are associated with dreamer user's recollection or analysis of the dreamt content. Computer devices, such as mobile devices such as mobile phones and the like, linked together via networks, such as the Internet, enable individuals to freely and instantly communicate with each other. The dynamic social linking system enables a dreamer user to share more openly on the non-conscious connections being reported by other users via a dream feed. The dream feed enables and informs other parties in the network that the dreamer user individual ‘A’ has dreamt of individual ‘B’, thus broadly communicating the non-conscious connections of third parties. Embodiments of the invention are described with respect to the drawings, and reference to the system is referred to and described as a dream register in accordance with an embodiment of the invention.

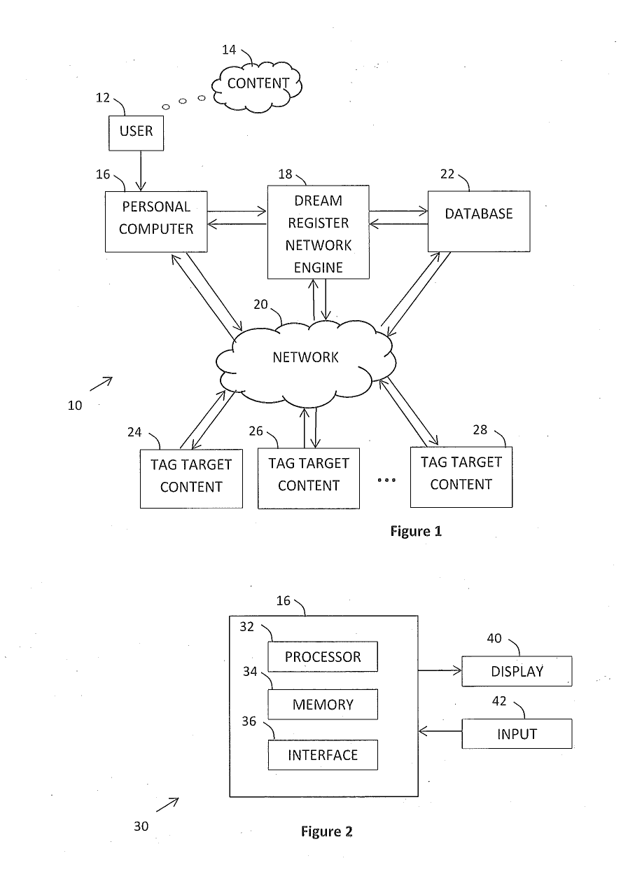

Referring to FIG. 1, FIG. 1 illustrates a block diagram of an exemplary system 10 on which various embodiments of the invention may be implemented. A user 12 may have content 14 to enter the system upon accessing the system 10 with a user device 16 such as a personal computer, mobile device, mobile telephone, or the like that is in communication with a server such as dream register network engine 18 and database 22 via a network 20, such as a local area network (LAN), intranet, internet or the like. The server 18 may communicate directly with the personal computer 16 and/or the database 18. The content may comprise dream content of the user, which may comprise details of users and objects that are tagged 24, 26, 28 for notification to any associated user. For example a name identified in the dream content may be associated with a registered user in the network.

FIG. 2 illustrates a block diagram 30 of an exemplary personal computer, user device, or the like 16 that may be implemented in the system of FIG. 1 in accordance with an embodiment of the invention. The personal computer comprises a processor 32 and memory 34 for processing and storing data, respectively, and executing the various data modules and software commands installed to perform various functions on the portable communications device. The personal computer 16 comprises a communications interface 36 to transmit and receive data via the network 20 including cellular networks and other networks such as local area networks LAN, intranet, internet and the like. The personal computer device may comprise data input 42 means such as a keyboard, camera, microphone, and the like, and data output means 40 such as a display, printer, and the like.

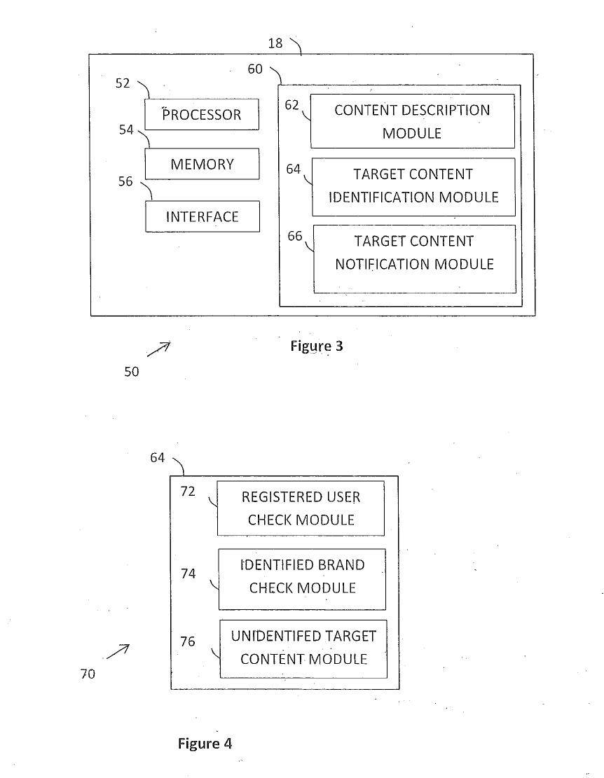

FIG. 3 illustrates a block diagram 50 of an exemplary dream register network server or engine 18 that may be implemented in the system of FIG. 1 in accordance with an embodiment of the invention. The dream register network server or engine 18 comprises a processor 52, memory 54, interface 56, and dream register network engine module 60. The dream register network engine module keyword analyser module 60 comprises various modules including but not limited to a content description module 62, a target content identification module 64, and a target content notification module 66.

FIG. 4 illustrates a block diagram 70 of an exemplary target content identification module 64 that may be implemented in the server 18 of FIG. 3 in accordance with an embodiment of the invention. The target content identification module 64 comprises a various modules including but not limited to a registered user check module 72, an identified brand check module 74, and unidentified target content module 76.

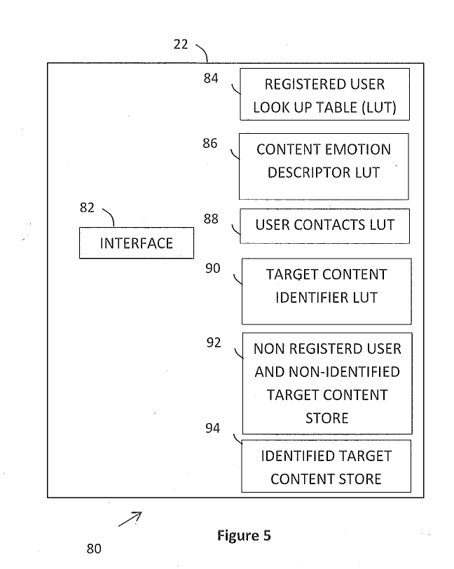

FIG. 5 illustrates a block diagram 80 of an exemplary database 22 that may be implemented in the system 10 of FIG. 1 in accordance with an embodiment of the invention. The database 22 comprises a communications interface 82 to transmit and receive data via networks 20 such as local area networks LAN, intranet, internet and the like. The database comprises a data store for registered user look up table (LUT) 84, content emotion descriptor LUT 86, user contacts LUT 88, target content identifier LUT 90, non-registered user and non-identified target content store 92, and identified target content store. The data may be stored in the database, or may be stored and received in other sources, such as other databases, server, external means, personal computer, or the like. Although the database is shown as a standalone unit, it will be appreciated that the database 22 or each data store 84, 86, 88, 90, 92, 94 may reside within the server or personal computer in the system our external to the system shown.

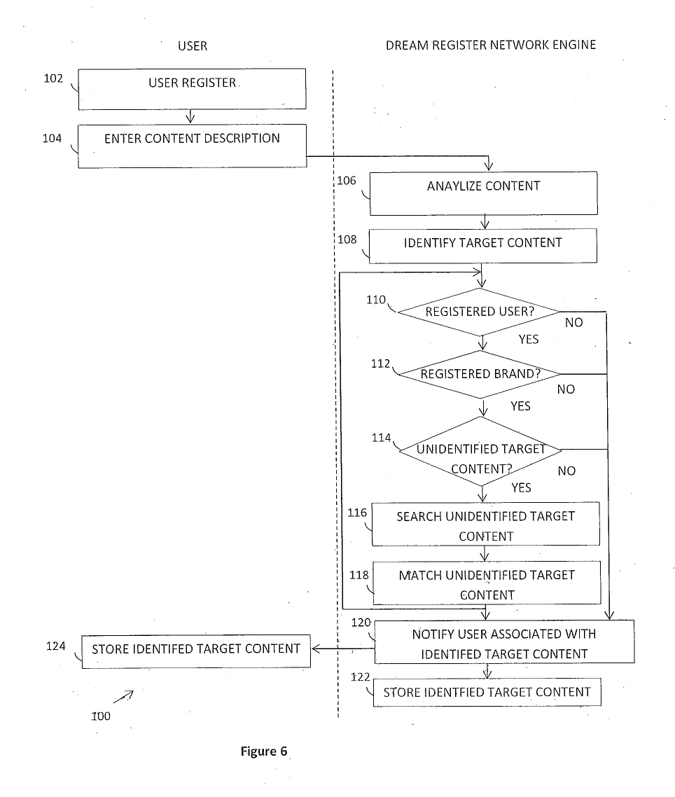

FIG. 6 illustrates a flow chart 100 of a method in accordance with an embodiment of the invention. The flow chart shows the actions from the perspective of the user as shown on the left of the vertical dashed line, and the actions from the perspective of the dream register network engine on the right of the vertical dashed line. The method comprises receiving a user registration 102 of a user. Once registered, the user enters content description or record of the user's recollection or analysis of the user's dream. The dream register network engine then analyses the content 106 to identify target content 108 within the content description or record. The target content is matched against registered users 110, registered brand 112. For example, the target content may identify a name of a person that is a user that is registered in the system. The target content may identify a name of a person that is not a registered user in the system. Accordingly, the system may identify the target content as a name, which may be identified by the user by inputting into the correct field in the graphical user interface, however, the name is not matched with a registered user. Accordingly, the system may send notification to the non-registered person via further information supplied by the user. Although the flow chart shows an analysis and identification of target content for registered user and registered brand, it will be appreciated that the system may look for other unidentified target content 114. The target content may identify other content other than users, such as for example, brands, clubs, companies, other objects, etc. The system may search 116 and match 118 the unidentified target content with particular users, registered or nonregistered users. The system then notifies 120 the user associated with the target content, and the details of the identified target content associated with the user and the user details are stored in the dream register network engine database 122 and may also be stored on the user device 124. The dreamer user may also be notified of the notification of the other user identified in the target content.

Upon registration which may include new user sign-up via e-mail, an existing social network, or the like, the user may opt visibility of the dream, i.e. visible to everyone, private, visible to friends, or the like. The dream user completes the field “I dreamt of” field, which will be suggested from the list of contacts the user has already had an association with as a “contact”, “friend”, or the like. Also, the user may input details of another person not yet in the system, and input the association with the user, or other association.

It will also be appreciated that it is possible to log a dream about someone not personally known to the user, such as for example a celebrity, sports personality or the like. In this case, the user enters known (or assumed) information about that person e.g. age group, country of residence. If the person dreamt about is also a user, they will be sent a “Is this you?” notification, and it may be optional to verify i.e. have a notification sent back to the originator, or ignore. This search function capability presents possible matches between a new dream logged via “Add dream” and the target content, including first name, last name, country of residence, country of origin, email address, age group, and the like. In an embodiment where there are a number of possible matches, for example three or more target content matches, the dream will be included in a report populated as, “Is this you?”.

In another embodiment an entity may create a user profile, for example, band, sports club, business, and the like. The user may dream about an individual or an entity or other objects with significance. If a user dreams of a person who is not a registered user, they will still be able to log the dream. If that dreamt person registers as a user, they will receive a feed of all the possible matches of dreams logged that may have been about them, with an option to verify, for example, send a notification and have this record retained in their own dream log, ignore, or the like.

A feature of the system in accordance with an embodiment is to capture the ‘when’ factor of the dream and the duration options, such as for example: a) in the last 24 hours; b) in the last 48 hours; c) in the last week; or the like. This duration component is a feature incorporated into the system that highlights when two users dream of one other during the same time period. The system will automatically capture details from the phone, and then the user will be able to edit if necessary (e.g. if traveling and phone settings are still set to home country).

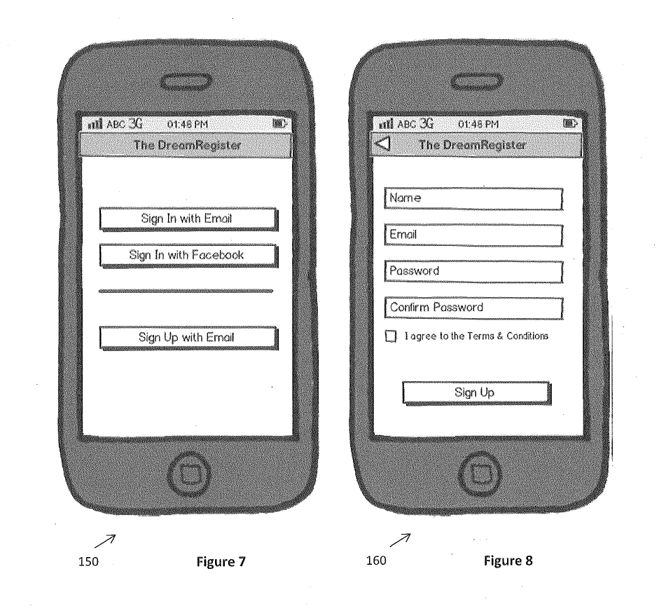

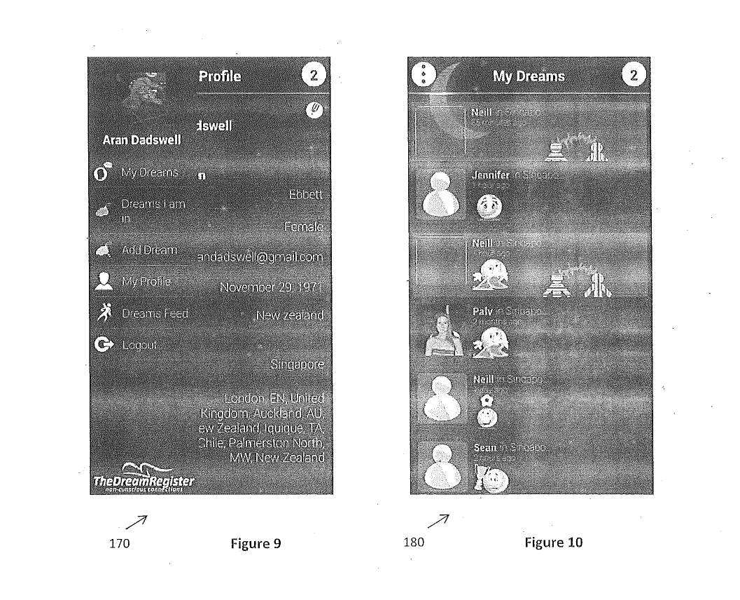

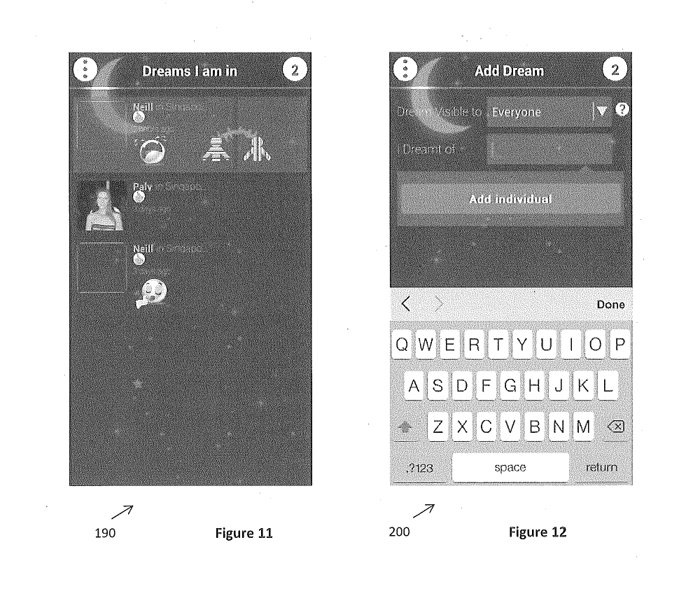

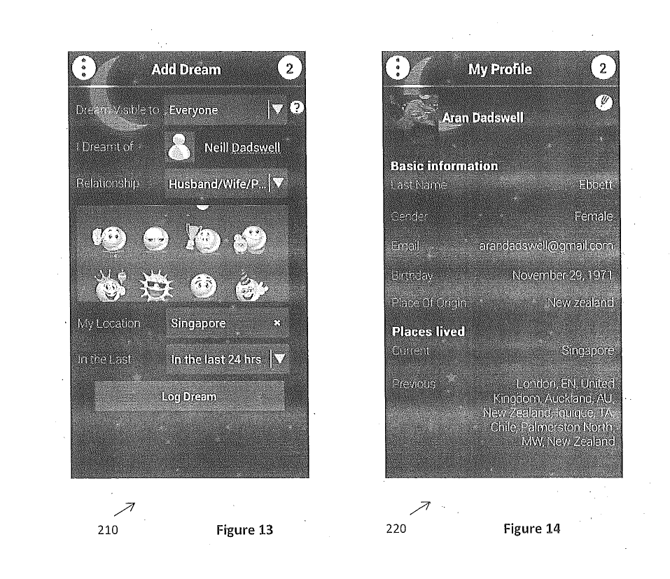

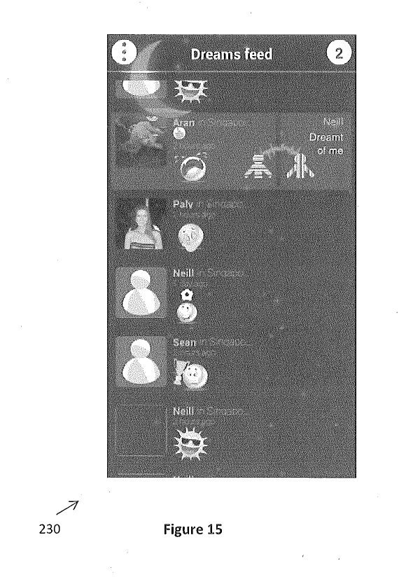

An example identifying the target description or record content social linking dream register system in accordance with an embodiment of the invention is applied to the following illustration of source of information as shown in graphic user interfaces 150, 160, 170, 180, 190, 200, 210, 220, 230 shown in FIGS. 7 to 15, respectively. FIGS. 7 and 8 illustrate schematics of a user device display with a graphical user interfaces 150, 160 showing input of content description for log-in and registration processes. FIGS. 9 to 15 illustrate graphical user interfaces arranged to be displayed on a user device display showing input of content description in accordance with embodiments of the invention. The above body of text is an example for illustrative purposes only. The user may register into the system in various ways. For example, users may enter the system via a social network website such as FACEBOOK, LINKEDIN, or the like. FACEBOOK is a trademark or registered trademark of Facebook, Inc. of Palo Alto, Calif., United States of America. LINKEDIN is a trademark or registered trademark of LinkedIn Corporation of Mountain View, Calif., United States of America. Details retrieved from the social networks may include for example name, date of birth, location, an image or photograph, or the like. In the system each user may manage a profile containing information such first name, last name (current), last name (previous), country of origin, country of residence (current and previous), age group, date of birth, an image or photograph, or the like. It will be appreciated that not all information is mandatory.

It will be appreciated that the system focuses mainly on the ‘who’ and ‘when’ aspect of dreaming i.e. who did you dream of, and when. In an embodiment, there is an opportunity to represent the ‘what’, i.e. the content or underlying emotion or sense of the dream at a high level, by selecting one of the emoticons available. In one embodiment, there may be no text fields, intentionally limiting the information shared on the content or description of the dream itself. It will be appreciated that the registered user LUT, content emotion descriptor LUT, user contacts LUT, and target content identifier LUT, are for illustrative purposes only. In accordance with embodiments of the invention the LUTs may take different forms and variations. For example, additional LUTs may comprise different target content identifiers and may be used in conjunction with or replace any one or all of the LUTs shown and discussed. The content emotion descriptor may comprise emoticons such as funny, happy, scary, weird, high 5, hand shake, spooky, crazy, hilarious, sweet, romantic, confused, holding up a gold trophy e.g. world cup (sports), champagne, winning a medal, sun, snow, football, rugby, tennis, singing, golf, driving, flying, blowing a kiss, dancing, playing guitar, firefighter, police man, rock star, cool, blushing, angry, geek, studying, at computer, nightmare, bandit, party, birthday cake, meditating, cowboy, king, queen, fighting, doctor (or nurse) treating a patient, hugging, rap artist, swimming, superhero, or the like. The emoticons are made available for selection, to enable users to create a high-level overview of the dream. Most emoticons are designed to describe an emotion e.g. happy, scary, funny or theme e.g. studying, at computer, football, or action e.g. playing guitar, blowing a kiss, meditating or role e.g. superhero, king, bandit, rock star. In an embodiment, the selection of an emoticon is entirely at the discretion of the user.

In another embodiment, an emoticon may be selected to provide a high level view on the content or context of the dream, instead of, in place of, or in addition to text fields or the like to enable the user to include a description of the dream.

The dynamic social linking system and method for linking users within a network in accordance with an embodiment of the invention may be adapted for any type of user device such as personal computer, mobile phone, and the like. Additional services may be added to the method and system in accordance with embodiments of the invention such as translation services and the like.

In an embodiment of the system the categories of relationships may include relationships that are no longer current, for example, a user may dream about an old colleague/school friend whom he/she has not had any contact with for years. The “Is this you?” feature of the system enables the user to log a dream about someone, even if they are unsure on all of the details, for example, that person's current location, age, email address. If the user opts for the specific dream to be made visible publicly, then when/if that person is or becomes a user of system they will receive a “Is this you?” log detailing dreams that they may have possibly featured in, based on a database match.

In embodiments, features may include a dreams feed that shows other people's dreams (if they have selected visibility, everyone or friends) for example in a dreamer user's dreams feed the dreamer user may see that the dreamer sister has dreamt about the dreamer user's mother.

In an embodiment, categories of people that are dreamt about may be included, and the statistics uploaded to a supporting website, for example brother/sister, friend, husband, wife, partner, colleague, ex-boss, school friend, or the like.

In an embodiment, the “when” component of the dream being logged will enable any matches to be recorded and highlighted, such as if a user dreams about the user's sister within a 48 hour time period, and the sister also dreams about the user within the same 48 hour time period, then the user and the sister will receive a ‘special’ notification to indicate this as a match, for example, fireworks or some other form of celebration/jubilation, or the like.

In embodiments, scientific institutions will be able to apply to connect directly to the database if they are interested in using the data recorded to understand non-conscious connections. For this purpose, this embodiment may include a data integrity clause that emphasizes the importance of data integrity to users as they complete the registration process, and to ensure the data captured is accurate and correct. For example, scientific research may be conducted external to the system, and the information recorded in the database would be accessed via an application programming interface (API) directly connecting to the database, and not the application itself in accordance with an embodiment.

Although the exemplary embodiments are described of applications in dynamic social linking system for linking users within a network comprising a plurality of users, and the like, the exemplary embodiments are applicable to any suitable application, such as digital and non-digital content, devices, software, services, goods, resources, and the like, and may be practiced with variations in technology, interface, content, rights, offerings, services, speed, size, limitations, devices, and the like.

The devices and subsystems of the exemplary methods and systems described with respect to FIGS. 1 to 8 can communicate, for example, over a communication network, and can include any suitable servers, workstations, personal computers (PCs), laptop computers, handheld devices, with visual displays and/or monitors, tablets, telephones, cellular telephones, smartphones, wireless devices, personal digital assistants (PDAs), Internet appliances, set top boxes, modems, other devices, and the like, capable of performing the processes of the disclosed exemplary embodiments. The devices and subsystems, for example, may communicate with each other using any suitable protocol and may be implemented using a general-purpose computer system and the like. One or more mechanisms may be employed, for example, including internet access, telecommunications in any suitable form, such as voice, modem, and the like, wireless communications media, and the like. Accordingly, the network may include, for example, wireless communications networks, cellular communications networks, public switched telephone networks (PSTNs), packet data networks (PONs), the Internet, intranets, hybrid communications networks, combinations thereof, and the like.

It is to be understood that the embodiments, as described with respect to FIGS. 1 to 8, are for exemplary purposes, as many variations of the specific hardware used to implement the disclosed exemplary embodiments are possible. For example, the functionality of the devices and the subsystems of the embodiments may be implemented via one or more programmed computer system or devices. To implement such variations as well as other variations, a single computer system may be programmed to perform the functions of one or more of the devices and subsystems of the exemplary systems. On the other hand, two or more programmed computer systems or devices may be substituted for any one of the devices and subsystems of the exemplary systems. Accordingly, principles and advantages of distributed processing, such as redundancy, replication, and the like, also may be implemented, as desired, for example, to increase robustness and performance of the exemplary systems described with respect to FIGS. 1 to 8.

The exemplary systems described with respect to FIGS. 1 to 8 may be used to store information relating to various processes described herein. This information may be stored in one or more memories, such as hard disk, optical disk, magneto-optical disk, RAM, and the like, of the devices and sub-systems of the embodiments. One or more databases of the devices and subsystems may store the information used to implement the exemplary embodiments. The databases may be organized using data structures, such as records, tables, arrays, fields, graphs, trees, lists, and the like, included in one or more memories, such as the memories listed above.

All or a portion of the exemplary systems described with respect to FIGS. 1 to 8 may be conveniently implemented using one or more general-purpose computer systems, microprocessors, digital signal processors, micro-controllers, and the like, programmed according to the teachings of the disclosed exemplary embodiments. Appropriate software may be readily prepared by programmers of ordinary skill based on the teachings of the disclosed exemplary embodiments. In addition, the exemplary systems may be implemented by the preparation of application-specific integrated circuits or by interconnecting an appropriate network of component circuits. Advantageously, the exemplary embodiments described herein may be employed in offline systems, online systems, and the like, and in applications, such as TV applications, computer applications, DVD applications, VCR applications, appliance applications, CD play applications, and the like. In addition the signals employed to transmit the summary data, and the like, of the exemplary embodiments, may be configured to be transmitted within the visible spectrum of a human, within the audible spectrum of a human, combinations thereof, and the like.

Embodiments of the invention have been described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by the applicable law. Moreover, any combination of the above-described elements in all possible variations thereof is encompassed by the invention unless otherwise indicated herein or otherwise clearly contradicted by context.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

Each of the applications and patents mentioned in this document, and each document cited or referenced in each of the above applications and patents, including during the prosecution of each of the applications and patents (“application cited documents”) and any manufacturer's instructions or catalogues for any products cited or mentioned in each of the applications and patents and in any of the application cited documents, are hereby incorporated herein by reference. Furthermore, all documents cited in this text, and all documents cited or referenced in documents cited in this text, and any manufacturer's instructions or catalogues for any products cited or mentioned in this text, are hereby incorporated herein by reference.

Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in this or related fields are intended to be within the scope of the claims.

1. A dynamic social linking system for linking users within a network accessible to a plurality of users, the system comprising:
a processor configured to receive a dreamt content record of a recollection of a dream of the dreamer user, the dreamt content record comprising at least one target content associated with another user within the network; and
a database for storing user details and associated target content registered within the network;
the processor analysing dreamt content record of the dreamer user and identifying the target content within the dreamt content record associated with another user within the network, and notifying the user associated with the target content of the dreamt content record of the dreamer user.

2. A system according to claim 1, in which the processor further comprises analysing the dreamt content record and identifying unregistered users of the network.

3. A system according to claim 1, in which the dreamt content record comprises a content emotion descriptor.

4. A system according to claim 3, in which the content emotion descriptor is an emoticon.

5. A system according to claim 1, in which the target content is a name associated with another user.

6. A system according to claim 1, in which the target content is a relation identifying a relationship the dreamer user has with another user.

7. A system according to claim 1, in which the target content is pulled from other social networks.

8. A system according to claim 1, in which the dreamt content record is a time factor.

9. A system according to claim 8, in which the processor notifies the dreamer user and a user associated with the target content if at least two dreamt content records having time factors within a predetermined time.

10. A system according to claim 9, in which the predetermined time is 48 hours.

11. A system according to claim 9, in which the predetermined time is 24 hours.

12. A dynamic social linking method for linking users within a network accessible to a plurality of users, the system comprising:
receiving a dreamt content record of a recollection of a dream of the dreamer user, the dreamt content record comprising at least one target content associated with another user within the network; and
storing user details and associated target content registered within the network;
analysing dreamt content record of the dreamer user and identifying the target content within the dreamt content record associated with another user within the network, and notifying the user associated with the target content of the dreamt content record of the dreamer user.

13. A method according to claim 12, in which the processor further comprises analysing the dreamt content record and identifying unregistered users of the network.

14. A method according to claim 12, in which the dreamt content record comprises a content emotion descriptor.

15. A method according to claim 14, in which the content emotion descriptor is a emoticon.

16. A method according to claim 12, in which the target content is a name associated with another user.

17. A method according to claim 12, in which the target content is a relation identifying a relationship the dreamer user has with another user.

18. A method according to claim 12, in which the target content is pulled from other social networks.

19. A method according to claim 12, in which the dreamt content record is a time factor.

20. A method according to claim 19, in which the processor notifies the dreamer user and a user associated with the target content if at least two dreamt content records having time factors within a predetermined time.

21. A method according to claim 20, in which the predetermined time is 48 hours.

22. A method according to claim 20, in which the predetermined time is 24 hours.
